(19) United States
(12) Patent Application Publication
(10) Pub. No.: US 2002/0161597 A1
(43) Pub. Date: Oct. 31, 2002

(54) System and method for interactively establishing a dispute resolution procedure

(76) Inventor: Alexander Klibaner, Berkeley, CA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/893,034

(22) Filed: Jun. 27, 2001

Related U.S. Application Data
(60) Provisional application No. 60/214,877, filed on Jun. 28, 2000.

(51) Int. Cl. G06F 17/60

(52) U.S. Cl. 705/1

(57) ABSTRACT

The on-line system and method of the present invention may allow two or more parties to a dispute to resolve their dispute over a communications network. This system and method may eliminate the need, in most instances, for in-person appearances of the parties to the dispute before the arbitrator, mediator, or other neutral party. In addition, this system may provide an efficient way for the parties to choose the rules, regulations and procedures which will apply in the dispute resolution process itself. It may further allow the parties to take into account potential variation among the parties' willingness to pay for particular rules, regulations or procedures.

### CROSS REFERENCE TO RELATED APPLICATIONS

This application claims the benefit of prior-filed provisional application No. 60/214,877, filed Jun. 28, 2000 and entitled System And Method For Interactively Establishing A Dispute Resolution Procedure, which is incorporated herein by reference.

### BACKGROUND

1. Field of the Invention

The present invention relates generally to dispute resolution, and more particularly to a system and method for interactively establishing a dispute resolution procedure.

2. Related Art

In order to avoid the high costs and lengthy delays of litigation, parties to disputes in many industries have begun turning to alternative forms of dispute resolution such as mediation and arbitration. Mediation is a process in which one or more neutral individuals, the mediator(s), assist the parties to a dispute in reaching their own settlement and/or in better understanding their positions. The mediator(s) may suggest possible avenues for resolution of the dispute, but generally do not have the authority to make a decision for the parties. Arbitration is a process in which each party presents its case before one or more neutral individuals, the arbitrator(s), who render a decision based on the parties' presentations.

Although arbitration and mediation are usually considered different forms of alternative dispute resolution, they need not be mutually exclusive. For example, a mediator may provide parties with a neutral evaluation of their dispute to help them gain another perspective on their respective situations. Conversely, an arbitrator may help parties negotiate a settlement (See, for example, California Code of Civil Procedure § 1297.301 which states, “It is not incompatible with an arbitration agreement for an arbitral tribunal to encourage settlement of the dispute and, with the agreement of the parties, the arbitral tribunal may use mediation, conciliation, or other procedures at any time during the arbitral proceedings to encourage settlement”).

Mediation and arbitration can be advantageous relative to litigation because they are generally cheaper for the parties, and often provide a significantly faster resolution of the dispute. For instance, the cost of arbitrating a dispute may be as little at $150 per party, and the arbitrator may render a decision within 30 days. By contrast, cases litigated in state or federal court may cost hundreds of thousands or even millions of dollars in attorneys' fees and costs, and may take many years to reach final judgment.

In traditional mediation and arbitration, the parties to the dispute appear simultaneously in-person before the mediator or the arbitrator. The necessity of a simultaneous in-person appearance by all parties to the dispute can be problematic for a number of reasons. First, the parties may not be located in the same geographical area, and in fact may live and work at opposite ends of the country or even abroad. In addition, the desired mediator or arbitrator may also be located far from the parties. Therefore, travel on the part of one or more parties and/or the mediator or arbitrator has historically been required. The costs of travel, such as transportation, lodging, and lost productivity, can be substantial. These costs can mitigate the cost savings of mediation or arbitration relative to litigation, thus reducing the parties' incentives to pursue alternative dispute resolution in the first place.

In addition to causing significant travel costs, the necessity of making an in-person appearance can also render scheduling of the mediation or arbitration session difficult. Often, the first available date on which the parties and the mediator or arbitrator are all available can be months away. During this delay, the dispute, which may be mission-critical to one or more of the parties, remains unresolved.

In some cases, mediation and arbitration have been attempted on-line, over communications networks such as the internet. However, many methods of alternative dispute resolution, including those currently implemented over networks such as the internet, require the parties to submit to a particular set of rules and procedures, and to split the applicable fees evenly between them. Often this approach is adopted (e.g., by a dispute resolution agency) to avoid burdening parties with substantial costs and delays which can be incurred in negotiating the details of a dispute resolution process (creating an unwelcome incidental dispute resolution activity along the way). This approach often may not allow the parties to choose the applicable rules themselves, and may not account for the parties' differing preferences and/or willingness to pay for particular rules and procedures, which may even combine traditional arbitration and mediation processes.

### SUMMARY

Some or all embodiments of the present invention may ameliorate the above and other drawbacks.

The system and method of the present invention may provide an efficient, interactive way for two or more parties to a dispute to choose the rules, regulations and procedures which will apply in the dispute resolution process themselves. It may further allow the parties to take into account potential variation among the parties' willingness to pay for particular rules, regulations or procedures. In addition, the system and method of the present invention may enable the parties to resolve their dispute over a communications network such as the internet, eliminating the need, in many instances, for in-person appearances of the parties to the dispute before the arbitrator, mediator, or other neutral party.

The system and method of the present invention may also provide a number of additional useful features, such as the generation of a contract containing the desired rules, regulations and procedures of the parties after those terms have been agreed upon. This contract may be generated automatically, or it may be discretionary with the parties. In some embodiments of the invention, the contract may also be modified by the parties if they wish.

In one embodiment, a method of resolving a dispute between two or more parties is disclosed. The method comprises the steps of obtaining agreement of the two or more parties to resolve the dispute, receiving preferences from each of the two or more parties for procedures to be followed in resolving the dispute, determining whether the preferences of the two or more parties for the procedures are consistent; if the preferences of the two or more parties for one of the procedures are not consistent, prompting one or more of the two or more parties for amended preferences, and, optionally, resolving the dispute in accordance with the procedures upon which the preferences of the two or more parties are consistent.

In another embodiment, a system for resolving a dispute between two or more parties comprises at least one host computer, and a website which is accessible to two or more parties and to the at least one host computer, the website including an input mechanism adapted to receive input from the two or more parties regarding preferences of the two or more parties for one or more procedures to be followed in resolving the dispute, wherein, via the website, the two or more parties may negotiate and agree upon a set of rules for resolving the dispute.

In yet another embodiment, a program may be stored on a computer-readable medium which, when executed, performs the steps of obtaining agreement of two or more parties to resolve a dispute, receiving preferences from each of the two or more parties for procedures to be followed in resolving the dispute, and determining whether the preferences of the two or more parties are consistent. Additionally, the program may notify a neutral to resolve the dispute in accordance with the preferences of the two or more parties if the preferences of the two or more are consistent, and receive amended responses from the two or more parties if the preferences of the two or more parties are not consistent.

### BRIEF DESCRIPTION OF THE DRAWINGS

Aspects of the present invention will be understood more clearly from the following detailed description and from the accompanying figures. This description is given by way of example only and in no way restricts the scope of the invention. In the figures,

FIG. 1 is a block diagram of a system according to one embodiment of the present invention allowing two or more parties to a dispute to resolve the dispute interactively via a communications network.

FIG. 2 is a high level flow chart of one embodiment of the operation of the dispute resolution process of the present invention.

FIG. 3 is a detailed flow chart of the functional logic contained within step 204 in FIG. 2.

FIG. 4 is a detailed flow chart of the functional logic contained within step 206 in FIG. 2.

### DETAILED DESCRIPTION

The system and method of the present invention allows two or more parties to a dispute to choose the rules, regulations and procedures which will apply in the dispute resolution process themselves. It may further allow the parties to take into account potential variation among the parties' willingness to pay for particular rules, regulations or procedures. Rather than being confined to pre-determined rules set by the neutral party, some embodiments may allow the parties to control (or at least influence) what portions of the various procedural aspects of the dispute resolution process each is willing to pay for and what percentage of the total cost of adhering to the procedures each is willing to bear. In addition, the system and method of the present invention may enable the parties to resolve their dispute over a communications network such as the internet, eliminating the need, in many instances, for in-person appearances of the parties to the dispute before the arbitrator, mediator, or other neutral party.

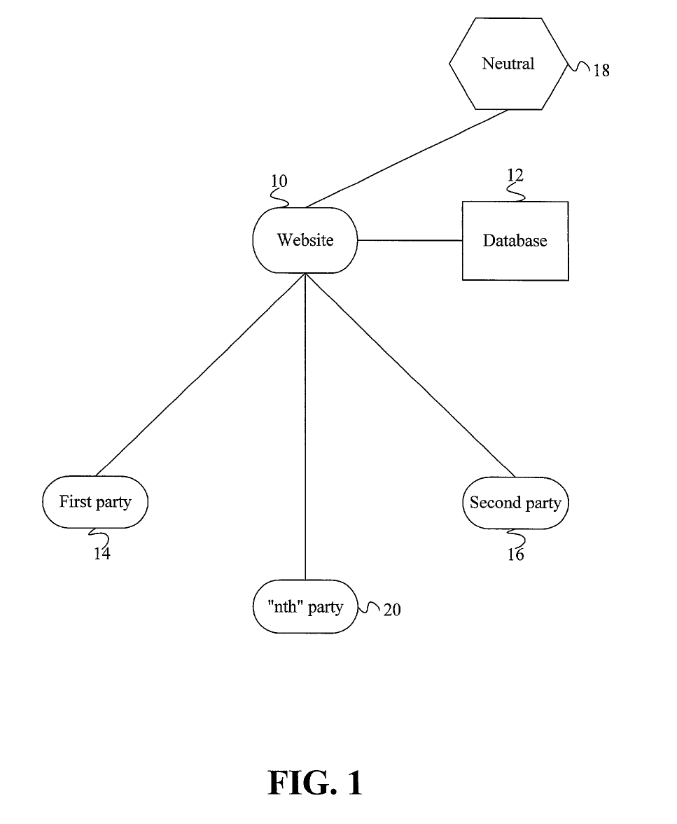

FIG. 1 shows an example of a system by which two or more parties to a dispute, such as a first party 14 and a second party 16, may resolve their dispute interactively over a communications network. In order for first party 14 and second party 16 to communicate with one another and with the neutral party 18, they log on to the internet website 10. The parties place information on website 10 which is then accessible to the neutral party 18. In the same manner, the neutral party 18 can communicate with either or both of the first party 14 or second party 16 by connecting to the website 10, placing information on the website 10, and allowing the first and second party to access the information.

In some embodiments, more than two parties may be related to the dispute. Thus, for the sake of completeness, FIG. 1 also shows an “nth” party 20. As one of ordinary skill would readily realize, the systems and methods taught herein may be applicable between two parties or any number of additional parties greater than two.

The information placed on the website 10 is preferably stored and maintained in a database 12. The information stored in the database 12 may be any information relevant to resolving the dispute. For instance, the information stored in the database 12 may include the parties' preferences for the rules, regulations and procedures governing the dispute and information about the parties' willingness to pay for the use of those rules, regulations and procedures. The information stored in the database 12 may also include briefs and reply briefs filed by the parties, other submissions by the parties to the neutral or to one another, communications from the neutral to one or more parties, transcripts of hearings or oral arguments (which may take place via e-mail, live on-line chat sessions, telephone, facsimile, video-conferencing, web conferencing, in-person meetings, or any other appropriate communications forum or medium), interrogatories, answers to interrogatories, requests for discovery of documents, witness statements, examinations and cross-examination of witnesses, expert witness reports, deposition transcripts, physical and mental examination records, statements of assets, motions of various sorts, case management tools and documents, scheduling tools and documents, lists and descriptions of available and chosen rules, and the like.

The materials, documents and information stored in database 12 may be available to all parties and to the neutral 18, or alternatively it may only be available to one or some of the parties and/or the neutral 18. In some cases the parties may agree, for instance by contract or by stipulation, that certain materials, documents or information will be available only to certain parties rather than to all of the parties. Alternatively, the neutral 18 may exercise authority to restrict the availability of some materials, documents or information. This availability may be restricted in any appropriate way, including encryption, the use of password protection, or other appropriate means. For security reasons, the website 10 preferably includes the ability to accept—and may require—a user log-in and password in order to allow access.

FIG. 1 shows a first party 14, a second party 16 and an “nth” party 20 to a dispute, as well as a neutral 18, having access to website 10. This illustration is not intended to be limiting. Configurations enabling resolution of disputes with any number of parties are contemplated. The parties may be individuals, corporations, governments or any other organizations or entities which may become involved in any kind of dispute. In some cases, the parties may take part in the dispute resolution contemplated by the present invention through an agent or other representative. In other cases, the parties may take part in the dispute resolution directly. In yet other cases, one or more of the parties may be a computerized or otherwise automated representative of another entity, so long as the computerized or otherwise automated representative is capable of interfacing appropriately with website 10.

Neutral 18 may be a mediator, arbitrator or other neutral individual. Alternatively, neutral 18 may be a panel or group of individuals assigned to conduct a particular dispute resolution. In other cases, neutral 18 may be any appropriate entity or organization chosen to resolve the dispute.

First party 14, second party 16, neutral 18, website 10 and database 12 can be connected over any suitable communications network, such as the internet, an intranet, a WAN (wide area network), or a LAN (local area network). Each user preferably has access to a general purpose computer. The computer system includes devices which enable the general purpose computer to communicate information over the communications network. Such devices may include a modem to connect to an internet service provider, a high-speed access line to an internet, intranet, or other network or the like.

A general purpose computer typically includes the main unit connected to at least one output device which displays information to a user and at least one input device which receives input from a user. The main unit generally includes a processor connected to a memory system via an interconnection mechanism. The input device and the output device are also connected to the processor and memory system via the interconnection mechanism.

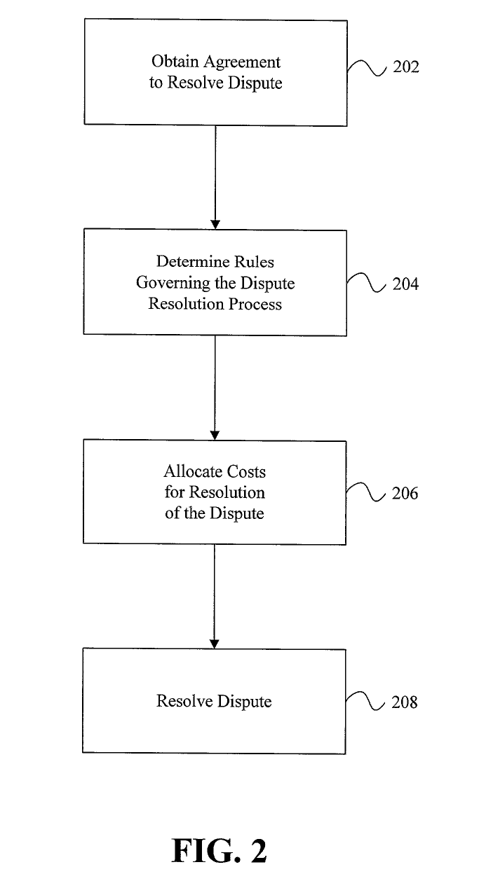

FIG. 2, a high level flow chart of one embodiment of the operation of the dispute resolution process of the present invention, shows steps involved in resolving a dispute. First, the agreement of the parties to resolve their dispute according to the dispute resolution process is received at step 202. In one scenario, the parties may have an existing contract in which they commit to resolve any disputes which may arise. The contractual term related to dispute resolution may specify the method by which disputes are to be resolved, e.g., arbitration or mediation. Additionally, the term may specify the neutral through which the parties will resolve their dispute, or the entity which will supply that neural, such as www.intellicourt.com. Alternatively, if the contractual term does not specify the details of the dispute resolution process to be used, the parties may still agree after a dispute arises to resolve the dispute in accordance with a system or method substantially conforming to that of the present invention.

After reaching preliminary agreement to resolve their dispute, which may but need not be accomplished on website 10, the parties may log on to website 10 to register their dispute for resolution. The parties may conduct this initial registration procedure individually or as a group. For security reasons, website 10 preferably includes the ability to issue and later accept a user log-in and password in order to allow access. Preferably, each party will choose or be issued a log-in and a password, and the system may require their use. The log-in and password may be issued or chosen according to any known or later-developed method. In an alternative embodiment, all of the parties to a particular dispute may be issued or may choose a common log-in and password.

After the agreement to resolve the dispute has been reached and registered in step 202, the process moves to step 204 where the rules, regulations or procedures governing the dispute resolution process are determined. As discussed in greater detail below, this step may include determining which rules, regulations or procedures will govern the dispute resolution process. In some embodiments, these rules, regulations or procedures may be determined based upon the preferences of parties to the dispute. The manner in which these rules, regulations or procedures are determined is discussed in greater detail below.

After the rules, regulations or procedures have been determined in step 204, an allocation of the costs to be borne by each party to the dispute is performed in step 206. Of course, step 206 may be omitted in some embodiments if the website 10 features predetermined allocation schemes or the parties agree to an allocation scheme without use of the website.

Regardless, the culmination of this process occurs in step 208 where the rules, regulations or procedures are followed with the hope that the dispute is resolved.

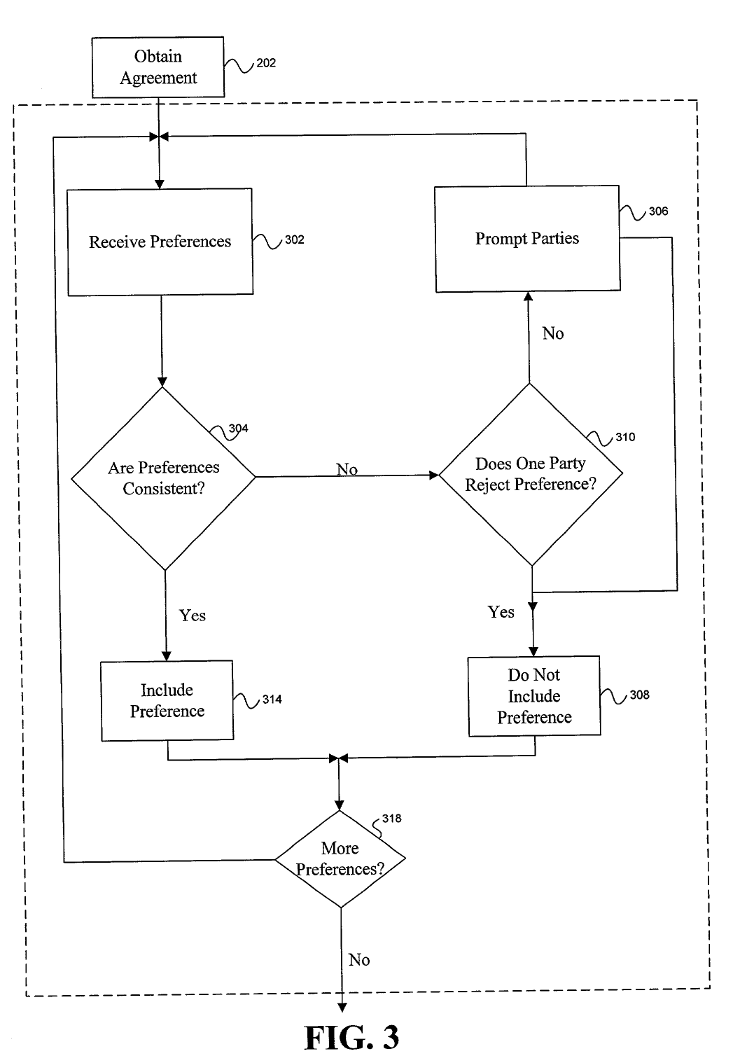

FIG. 3 is a more detailed illustration of the process described in FIG. 2. As described earlier, the first step is to obtain an agreement to resolve the dispute at step 202. Step 202 may be referred to herein as a “registration process.” The remainder of the steps shown in FIG. 3 relate to the step labeled step 204 in FIG. 2. That is, the steps shown inside the dashed box of FIG. 3 may be part of the process of determining the rules that will govern the dispute resolution process.

After the registration process is complete, the parties each indicate their preferences, via website 10, for particular rules, regulations or procedures according to which the dispute resolution process will be conducted. These preferences, which may be kept confidential from the other parties, are received by the website 10 at step 302.

There are several categories of rules, regulations and procedures which may be involved in dispute resolution processes such as arbitration and mediation. These include, but are not limited to, methods of presenting a party's case to the neutral, discovery procedures, motions, rules of evidence, use of a mediation step, type and extent of analysis performed by the neutral, procedural rules, calendering rules, rules governing the submission of evidence and argument, remedies and powers available to the neutral, and other miscellaneous rules. Representative but not limiting lists of various options within each of these categories are provided in the following tables A through K.

TABLE A
(Methods of presenting a party's case to the neutral)

Opening brief - each party presents to the neutral an e-mail or other document containing
its arguments about the law and the facts. This document may also include the party's
statement of the relevant facts of the case.
Reply to opening brief - each party presents to the neutral an e-mail or other document
containing its arguments about the law and facts in response to the opening brief of the
other party.
Hearing by e-mail.
Hearing by chat room.
Hearing by telephone.
Hearing by video conferencing.
Face-to-face hearing.
Oral arguments (after all evidence has been submitted, or at some other appropriate time) -
a hearing limited to the arguments of parties without the admission of any evidence, or
a more extensive hearing in which parties may submit evidence if they so choose.
Allowing the neutral to ask questions - agreeing to allow a neutral third-party to ask
questions of the parties and/or witnesses via e-mail or otherwise.
Closing statement - each party presents to the neutral an e-mail or other document
containing its final arguments about the law and the facts.

TABLE B
(Discovery procedures)

Form interrogatories - each party answers a predetermined set of questions or a subset of
the allowed questions as selected by another party.
Requests for documents - each party requests certain documents (or copies thereof) to be
provided by another party or by a third-party.
Exchange of evidence - each party discloses to each other party the documents or other
evidence that it plans to seek to be admitted.
Exchange of witness statements - each party discloses statements by the witnesses it
plans to present before the neutral.
Special interrogatories - each party asks another party a limited number of questions
prior to the time for admission of evidence. The questions may be limited in number to,
for example, 20 questions.
Questions/cross-examination of witnesses by e-mail, by on-line chat, by telephone, by
video conference, face-to-face, or by any other known or later-developed method.
Requests for admission - each party requests that another party admit certain statements.
If admitted, these statements become an established fact against the admitting party for
purposes of the dispute resolution process.
Reply round(s) of briefs after discovery, mediation, and/or preliminary analysis.
Depositions - a party asking questions of witnesses under oath prior to the admission of
evidence.
Depositions based on written questions.
Deposition by telephone.
Deposition by e-mail.
Deposition by on-line chat room.
Physical and mental examinations - having a physician or another medical professional
perform a physical or mental examination of a party or witness.
Motions to compel responses to discovery requests - the presentation of requests to the
neutral to order a party to comply with or respond further after receiving a discovery
request (e.g., interrogatory, deposition question, request for production of documents,
request for admission, etc.).
Exchange statement of assets - each party discloses all its assets or specific assets that
another party requests to be disclosed.
Exchange statement of income and expenses - each party discloses all its income and/or
expenses or specific income and/or expenses that another party requests to be disclosed.

TABLE C
(Motions)

Motion to dismiss for failure to state a claim - a request by one party that another party's
pleading be dismissed by the neutral because it does not state a legal basis on which a
valid claim may be based.
Motion for more definitive statement - a request by one party that another party's
pleading be dismissed by the neutral unless it is revised to provide a more specific or
more definitive statement of the basis of the claim.
Motion to strike matter in pleadings - a request by one party to dismiss another party's
pleadings in part or in whole.
Motion to strike testimony - a request by one party that a witness's testimony (in part or
in whole) be ignored by the neutral.
Motion to dismiss for lack of jurisdiction - a request by one party that the neutral dismiss
the case because any decision would exceed the neutral's authority.
Motion to dismiss for failure to join a necessary party - a request by one party that the
neutral dismiss the case because a party whose participation as a party in the case is
crucial to its just resolution is not a party to the case.
Motion to dismiss for failure to prosecute - a request by one party that the neutral dismiss
the case because another party has failed to proceed with the case within a set or
reasonable time.
Motion for extension of time - a request by one party for permission to present a pleading
or evidence or to perform an action after its deadline.
Motion for continuance - a request by one party to postpone a procedure or event within
a dispute resolution process until a later time.
Motion to amend pleading - a request by one party to modify a document presented to
the neutral.
Motion for judgment on the pleadings - a request by one party for the neutral to make a
decision on a case with the assumption that all the facts in another party's pleadings are
true.
Summary judgment - a request by one party for the neutral to make a decision on a case
as a matter of law and interpreting all contested facts in favor of the non-requesting party.
Partial summary judgment - a request by one party for the neutral to make a decision on
an issue or issues within a case as a matter of law and interpreting all contested facts in
favor of the non-requesting party.
Motion in limine (to exclude evidence) - a request by one party for the neutral to not
admit certain evidence.
Motion in limine (to admit evidence) - a request by one party for the neutral to admit
certain evidence.
Motion to establish a fact as true - a request by one party for the neutral to consider a
certain fact as true for the purposes of the parties' case.
Motion to dismiss - a request by one party for the neutral to dismiss the case.
Motion to disqualify counsel - a request by one party for the neutral to rule that another
party's attorney or representative cannot represent that party for the case.
Motion to join a party - a request by one party for the neutral to add an additional
individual or entity as a party to the case.
Motion to consolidate separate dispute resolutions - a request by one party to combine
two or more separate cases into one dispute resolution process.
Motion to conduct class arbitration - a request by one party to combine a class of cases
into one dispute resolution process.
Motion to join a cross-claim - a request by one party for the neutral to consider its
separate claim as part of the case.
Motion to extend the scope of the dispute resolution agreement - a request by one party
to expand the authority of the neutral.
Motion to appoint a special master for discovery purposes - a request by one party for the
neutral to appoint an individual to be the neutral for pre-admission-of-evidence or pre-
hearing issues.
Motion to appoint a special master for a particular finding of fact - a request by one party
for the neutral to appoint an individual to be the neutral for determining a particular issue
of fact.
Motion for reconsideration - a request by one party for the neutral to review his or her
decision and consider changing it.
Motion to expedite dispute resolution process - a request by one party to amend the
schedule for the case to be faster or shorter.
Motion to lengthen dispute resolution process - a request by one party to amend the
schedule for the case to be slower or longer.
Motion to correct or vacate award - a request by one party for the neutral to amend or to
cancel his or her decision.

TABLE D
(Rules of evidence)

Stipulation to facts not in dispute - an agreement by the parties to consider certain facts
as true for the purposes of their case.
In camera review of evidence to which there is an objection - a neutral's review of
materials to make a determination whether the material should be admitted into evidence.
Assume objections on all evidence - a request by a party or an agreement by the parties
that the neutral rule on the admissibility of each piece of testimony, document, or object
sought to be admitted into evidence.

TABLE E
(Use of mediation)

Settlement amount request from parties - the parties disclose settlement terms to a neutral
(or website, computer or other appropriate known or later developed instrumentality) that
then decides whether the terms match or are close enough to create a settlement.
Mediator's confidential settlement proposal - the neutral proposes settlement terms to the
parties, who then either accept or reject the proposal and their responses are kept
confidential by the neutral from the other party or parties.
Identification of interests - the neutral works with the parties to help them identify their
preferences.
Brainstorming session - the neutral works with the parties to help them identify their
preferences and options.
Discussion of strengths and weaknesses - the neutral works with the parties to help them
identify the strengths and weakness of their positions.
Risk analysis (decision tree) - the neutral works with the parties to try to quantify their
options and the outcome possibilities.
Facilitation of agreement on settlement terms - the neutral works with the parties to try to
bring the parties to agree on settlement terms.
Mediation caucus by e-mail - the neutral enters into a dialogue with one or more parties
via e-mail.
Mediation caucus by chat room - the neutral enters into a dialogue with one or more
parties using on-line chat room technology.
Mediation caucus by telephone - the neutral enters into a dialogue with one or more
parties via telephone.
Mediation caucus by video conferencing - the neutral enters into a dialogue with one or
more parties using video technology.
Mediation caucus by video e-mail - the neutral enters into a dialogue with one or more
parties using video e-mail.

TABLE F
(Type and extent of analysis performed by the neutral)

Preliminary analysis - the neutral provides the parties with an identification and/or
analysis of the issues involved in the case.
Tentative ruling - the neutral provides the parties with his or her decision prior to it
becoming the final decision in the case.
Immediate response - the neutral provides the parties with a decision without conducting
any legal research.
Paragraph-length decision - the neutral provides the parties with a decision and statement
of reasons for the decision that ranges from one to four paragraphs.
Statement of positions - the neutral provides the parties with a statement of what he or
she understands to be the parties' positions.
Finding of facts - the neutral provides the parties with a statement of what he or she
considers to be the true facts for purposes of the case.
Issue identification - the neutral provides the parties with a statement identifying the
issues in the case.
Legal research under California law or other specified law.
Specific city/town ordinance research.
Full-length opinion - a decision and statement of reasons for the decision. It may include
an introduction, a statement of the procedural history of the case, a statement of the facts
in the case, a statement of the law that applies to the case, and/or a statement of
arguments or reasons justifying the decision and/or how the parties' dispute should be
resolved.
Expedited decision - a decision issued within a specified time period from the end of the
period for admission of evidence and/or the parties' arguments. The time period may
range from minutes to months.

TABLE G
(Procedural rules)

The dispute resolution process should follow Federal Rules of Civil Procedure.
The dispute resolution process should follow any state's rules of civil procedure.
The dispute resolution process should follow the American Arbitration Association
Rules.
The dispute resolution process should follow a particular set of American Arbitration
Association Rules (e.g., employment, commercial, health care, technology, construction).
The dispute resolution process should follow JAMS Rules. JAMS is a private company in
the United States, which offers alternative dispute resolution services nationally. See
http://www.jamsadr.com.
The dispute resolution process should follow a particular set of JAMS Rules (e.g.,
employment, commercial, financial services, personal injury).
The dispute resolution process should follow a set of procedural rules determined by the
parties.

TABLE H
(Calendering rules)

Agree to have neutral set calendar for discovery.
Agree to a timetable for exchange of briefs (different timetables would be available, such
as extended, normal, expedited, super fast-track).
Agree to have a status conference with the neutral (by mail, e-mail, telephone, chat room,
video conference).
Required or discretionary imposition of a penalty for not adhering to the timetable for
submission of discovery, evidence and argument. (For example, failure to abide by the set
timetable may, in the neutral's discretion, prevent certain materials from being admitted
into evidence.)
Case management conference via e-mail - a dialogue via e-mail among the parties
concerning the status and/or administration of the case.
Case management conference via phone - a dialogue via phone among the parties
concerning the status and/or administration of the case.
Case management conference via chat room - a dialogue using chat room technology
among the parties concerning the status and/or administration of the case.
Case management conference via video conferencing - a dialogue using video
technology among the parties concerning the status and administration of the case.

TABLE I
(Rules governing the submission of evidence and argument)

Require a face-to-face hearing upon the request of any party.
Agree to limit the length of post-evidence briefs. (For example, the length of the brief
may be limited by a word count, with the highest or lowest proposed amount setting the
agreement, or an average of the two.)
Documents submitted by facsimile or by a scanned file in an acceptable electronic format
should be treated as original for evidence purposes.
Acceptance of video e-mail for declaration under oath.
Agree to allow the subpoenaing of third-party witnesses to the extent allowed by law.
Agree to allow the subpoenaing of third-party documents to the extent allowed by law.
Duty to supplement disclosures and discovery responses as new information becomes
available.
No ex parte motions (e.g., for continuances).
No ex parte motions except for particular ex parte motions such as motions for
continuances.
Ex parte motions allowed.
Neutral shall have powers necessary to perform various evidentiary review functions or
the like, pursuant to the parties' agreement.
The dispute resolution system should follow Federal Rules of Evidence or California
Evidence Code or any state's rules of evidence.
Agree that no party shall be allowed to object to evidence. The neutral shall have
discretion to consider the relevancy, materiality, and weight of the evidence in making
any decision.

TABLE J
(Remedies and powers available to the neutral)

Awarding costs.
Awarding attorneys fees.
Awarding punitive damages.
Awarding interest.
Awarding injunctive relief.
Awarding preliminary injunctive relief.
Ordering that an item be repaired by a party.
Ordering that an item be replaced by a party with a new item.
Ordering that certain funds be reimbursed by a party.
Order that an item be repurchased by a party.
Power to make an interim award.
Awarding declaratory relief.
Awarding anything allowed by law.
Awarding anything a court may award.
Awarding sanctions.
Awarding sanctions for failure to comply with a discovery order.
Awarding sanctions for bad faith behavior.
Losing party pays for costs.
Losing party pays for attorney fees of winning party.
Decision is reviewable for mistakes of law by any court having
jurisdiction.
Decision is reviewable for mistakes of law or fact by any court
having jurisdiction.
Decision is reviewable for clear error of law or fact by any court
having jurisdiction.

TABLE K
(Miscellaneous rules)

More than one neutral may be on the panel.
If there is more than one neutral on the panel, the parties may agree that the panel's
decision requires unanimity or a majority.
Selection of neutral—a procedure for selecting a neutral by having the parties rank with a
limited number of points neutrals on a particular list and considering the neutral with the
highest point totals as the neutral for the parties' dispute resolution process.
Levels of confidentiality—a procedure by which the parties separately select the level of
confidentiality that they would prefer for their dispute resolution process and a neutral (or
a computer) selects the highest common level of confidentiality. Choices might include,
but are not limited to, “no confidentiality,” “only names kept private,” “all identifying
information kept private,” “only specified information kept secret” (what each party
specifies to the neutral as confidential), “decision can be published,” “everything
confidential,” and “stipulation for a protective order.”
The decision of the neutral may be made binding on the parties, or may not be binding
on the parties.
E-mail or facsimile notice may be deemed to constitute sufficient service.
No oral hearings shall be held.
Settlement terms shall be recorded in the form of an arbitral award. (An arbitral award
includes any neutral's final decision or order).
Waive all fights with respect to the neutral's conflicts of interest, if any.

In some embodiments, each party may initially express either a requirement, willingness, or refusal to include a particular rule, regulation or procedure in the dispute resolution process.

In addition to expressing a willingness to include a particular rule, regulation or procedure in the dispute resolution process, each party will preferably express a willingness to pay some portion or percentage of the total cost of adhering to the rule, regulation or procedure. For instance, a party to a two-party dispute may express a willingness to pay for up to 75% of the cost of a paragraph-length decision by the neutral, while expressing a willingness to pay for only 25% of a full-length written decision by the neutral. In other cases, where a party desires a more detailed written opinion, those figures might be reversed or otherwise tilted towards a full-length written opinion by the neutral 18. Alternatively, a party's preference may be expressed in terms of a fixed amount rather than a percentage. This fixed amount can be turned into a percentage of the total cost of a procedure for calculation purposes if necessary.

After the preferences of all the parties are received, the system determines whether those preferences are consistent at step 304. In some embodiments, the preferences of the parties may be consistent if no party expresses a refusal to include a particular rule, regulation or procedure, and if the sum of the parties' willingness to pay meets or exceeds 100% of the total cost of adhering to that rule, regulation or procedure. If one of the parties expresses a refusal to include a particular rule, regulation or procedure, and/or if the sum of the parties' willingness to pay is less than 100% of the total cost of adhering to that rule, regulation or procedure, then the parties' preferences are inconsistent.

If the parties' preferences are inconsistent with respect to a particular rule, regulation or procedure because one or more parties has expressed a refusal to include it, then at step 310 the process goes to step 308 where the procedure is removed from consideration. In an alternative embodiment (not shown in FIG. 3) the process may automatically prompt the refusing party to reconsider his or her decision in such a case. Alternatively, the process may prompt the refusing party to reconsider his or her decision only if another party to the dispute, or the neutral, so requests.

If the parties' preferences are inconsistent because the sum of their willingness to pay is less than 100% of the total cost of adhering to a rule, regulation or procedure, the system may prompt the parties for amended responses at step 306. In such a situation, the system may inform the parties, via the website, that all parties have expressed a willingness for the procedure in question, but that the requisite agreement to pay was not obtained. The parties may then submit amended preferences and the process returns to step 302.

According to some embodiments, if one of the parties expresses a requirement that a particular rule, regulation or procedure be included in the dispute resolution process, agreement must be reached on inclusion of that rule, regulation or procedure in order for the process to go forward. If one party expresses a requirement that the rule, regulation or procedure be included in the dispute resolution process, and either another party expresses a refusal to include the rule, regulation or procedure, or the sum of the parties' willingness to pay for the rule, regulation or procedure is less than 100%, the system may prompt the parties for amended responses. The process in such a case may be carried out much like the process described above with reference to steps 306 and 302.

In some embodiments, the process, or alternatively the neutral party 18, may impose a limit on the number of amended responses. In such an embodiment, the prompt step 306 may cause the process (possibly via an interrupt of an additional decision block not shown in FIG. 3) to move to step 308 where the rule, regulation or procedure is removed from consideration.

If the parties' preferences are consistent with respect to a particular rule, regulation or procedure, the process progresses to step 314 where the rule, regulation or procedure is included as a rule, regulation or procedure in the dispute resolution process. The entire process shown in FIG. 3 is then repeated for any rules, regulations or procedures which remain to be considered, as indicated at step 318 in FIG. 3.

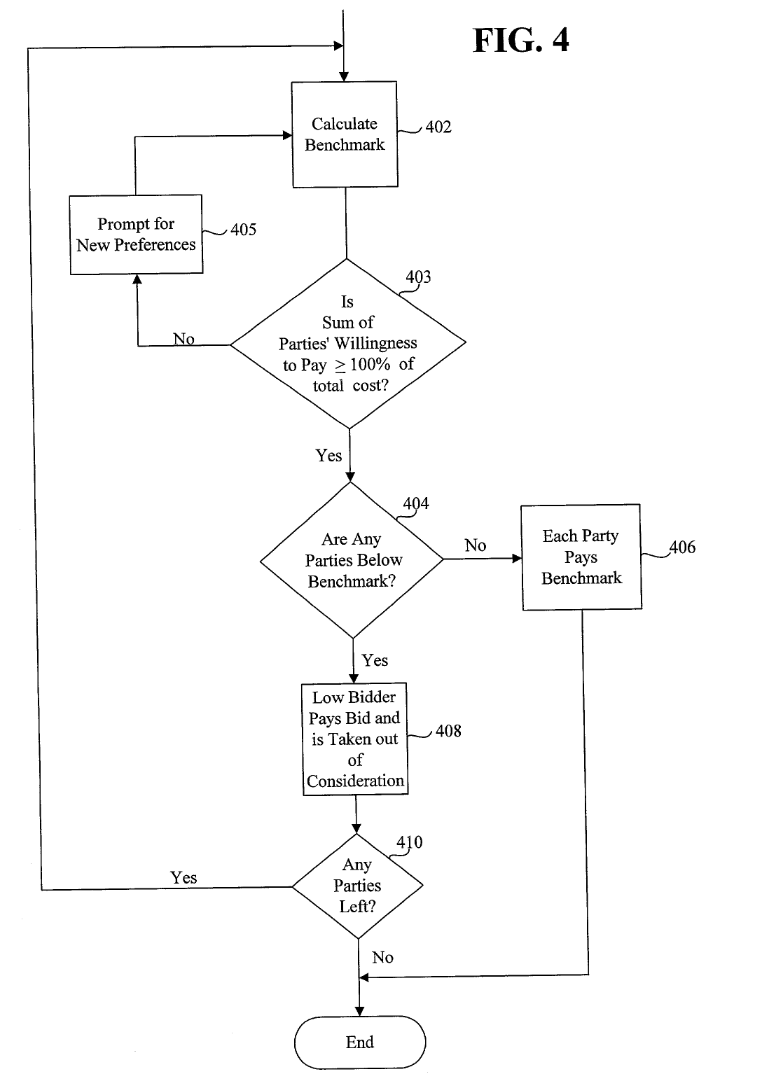

After the rules, regulations and/or procedures have been determined according to the process shown in FIG. 3 (which, as noted above, relates to the step labeled step 204 in FIG. 2), the cost of adhering to each rule, regulation or procedure (if any) may be allocated among the parties, as shown in FIG. 4. FIG. 4 relates to the step labeled step 206 in FIG. 2.

FIG. 4 is a detailed flow chart of the functional logic contained within step 206 in FIG. 2, showing one manner in which the cost of adhering to a rule, regulation or procedure may be allocated between or among the parties to a dispute. Of course, other methods may be used. Furthermore, as discussed above, in some embodiments the cost may need not be allocated if such an option is not available or applicable. For instance, certain costs may have a fixed or required allocation.

The cost allocation process begins at step 402 where a benchmark amount or percentage is calculated. A benchmark amount, as the term is used herein, represents an amount calculated by dividing the total cost of adhering to a rule, regulation or procedure by the number of parties to the dispute. In alternative embodiments a benchmark percentage may be used instead of a benchmark amount. The benchmark percentage is equal to 100% divided by the number of parties to the dispute.

The amount or percentage of the cost of adhering to a rule, regulation or procedure that each party is willing to pay may have been received as one of the preferences described above. If the sum of the willingness to pay of the remaining (discussed below) or original two parties does not meet or exceed 100% of the total cost of adhering to the rule, regulation or procedure, as determined at step 403, then the parties may be asked to agree to higher amounts at step 405. The new amounts the parties are willing to pay are then received and the process starts again at step 402. At step 404, it is determined whether any of the parties are below the benchmark amount or percentage. If all parties are willing to pay at least the benchmark amount or percentage of the cost for adhering to the rule, regulation or procedure in question, then each party pays the benchmark amount or percentage, as indicated at step 406, and the allocation process for that rule, regulation or procedure is complete.

If one or more of the parties is unwilling to pay the benchmark amount or percentage, then the party willing to pay the lowest maximum amount pays that amount, and is taken out of consideration for the remainder of the cost allocation, as shown at step 408.

After the lowest bidding party has been removed in step 408, the process, at step 410, then determines whether there are any parties that have not yet been taken out of consideration. If there are parties left, the process returns to step 402 where a new benchmark amount or percentage is calculated. This new benchmark may be called a “running benchmark” to distinguish it from an “initial benchmark” or “first benchmark” that is calculated before any parties are taken out of consideration.

The running benchmark amount is calculated by dividing the remaining cost (i.e., the total cost of the rule, regulation or procedure minus the portion of the cost already accounted for) by the number of remaining parties (i.e., the number of parties which have not yet been taken out of consideration).

In another embodiment, a running benchmark percentage may be calculated by dividing the running benchmark amount by the total cost of the rule, regulation or procedure.

When there are only two parties, only one benchmark calculation may be necessary. However, when there are three or more parties, calculation and/or recalculation of a running benchmark may be necessary each time a party is taken out of consideration at step 408.

This process may be repeated until no parties are below the running benchmark amount or percentage. Of course, the process of FIG. 4 may be repeated for each rule, regulation or procedure.

Preferably, the dispute resolution process takes place mostly or entirely over a communications network such as the one shown in FIG. 1. The dispute resolution process may take many different forms and may involve many different rules, regulations, procedures and processes. Some of these may take place in various ways and in various forums, besides the communications network. However, the communications network is the preferable forum.

The determination of rules, regulations and procedures to be used in the dispute resolution process, and the allocation of the costs therefore, may be done on an individual basis. Alternatively, groups of rules, regulations and procedures may be pre-selected for easier ratification and cost allocation. These groupings may take the form of suggested “templates” for how to conduct a particular type of dispute resolution process (e.g., arbitration, mediation, or arbitration with an optional or required mediation step). The templates may also vary depending on how much is at stake in a particular circumstance. For instance, if under $10,000 is in controversy between the parties, relatively little discovery may be desired by the parties, and a relatively short opinion (or even an oral opinion) may be requested of the neutral. However, if much more, for instance over $1,000,000 is in dispute between the parties, more extensive discovery, and a more detailed and thorough opinion from the neutral, may be desired by one or more parties.

Based on these types of factors, the system may offer suggested templates of rules, regulations and procedures for various circumstances. A template may contain a set of less than all of the possible choices of rules, regulations or procedures. Additionally, in other embodiments, the parties may alter these suggested templates themselves or may generate their own templates from scratch.

As noted above, the system and method of the present invention may also provide a number of additional useful features. One such feature is the compilation and/or publication of statistics regarding the frequency with which parties choose particular rules, regulations or procedures. These statistics may serve a number of useful purposes. For instance, the templates referred to above may be generated in light of these statistics, with seldom-chosen provisions left off and oft-chosen provisions included. In addition, the statistics may be published on-line or in any other appropriate format for the parties to see. In this way, the parties may be informed which rules, regulations and procedures are generally considered to be important, and which are not.

Another useful feature associated with some embodiments is the generation of a contract containing the desired rules, regulations and procedures of the parties after those terms have been agreed upon. This contract may be generated automatically by a document assembly program, or it may be discretionary with the parties. In some embodiments of the invention, the contract may also be modified by the parties if they wish.

The generation of a contract in this or a similar manner may have applications in a wide range of embodiments, some of which may involve dispute resolution, and some of which may not involve dispute resolution. For instance, when negotiating a contract in a variety of circumstances, it may be useful for the parties to the desired contract to enter their respective preferences for important contractual terms “blindly,” without the other party or parties knowing those preferences. A system, like the system described herein, may be used to determine whether the parties' preferences are consistent or inconsistent, and may eliminate negotiation over terms which the parties agree upon through the blind indication of their preferences. This leaves the parties, or their legal representatives, free to concentrate their energies on resolving any inconsistencies on the remaining points. Such a system can save a great deal of time and expense, and may have wide-ranging application not limited to the dispute resolution context. Furthermore, one of ordinary skill in the art, based on the disclosure herein, will be able to readily modify the above disclosure to accomplish such goals.

Having now described a few embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

1. A method of interactively establishing a dispute resolution procedure, comprising the steps of:
(a) obtaining agreement of two or more parties to resolve a dispute;
(b) receiving preferences from each of the two or more parties for procedures to be followed in resolving the dispute;
(c) determining whether the preferences of the two or more parties for the procedures are consistent; and
(d) if the preferences of the two or more parties for one of the procedures are not consistent, prompting one or more of the two or more parties for amended preferences.

2. The method of claim 1, further comprising the step of resolving the dispute in accordance with the procedures upon which the preferences of the two or more parties are consistent.

3. The method of claim 1, wherein steps (a), (b) and (d) are performed via a communications network.

4. The method of claim 3, wherein step (d) further comprises:
via the network, receiving the amended preferences of the two or more parties; and
determining whether the amended preferences are consistent.

5. The method of claim 1, wherein a preference comprises an agreement to utilize a procedure or a refusal to utilize the procedure.

6. The method of claim 5, wherein the preference further comprises an expression of a maximum willingness to pay for a portion of a total cost of adhering to the procedure.

7. The method of claim 6, wherein the expression of a maximum willingness to pay is expressed as a maximum percentage of the total cost of adhering to the procedure.

8. The method of claim 7, wherein the preferences of the two or more parties for the procedure are consistent if:
all of the preferences comprise agreement to utilize the procedure; and
a sum of the maximum percentages of the total cost of adhering to the procedure which each of the two or more parties are willing to pay is greater than or equal to 100%.

9. The method of claim 7, wherein the preferences of the two or more parties for the procedure are inconsistent if:
at least one of the preferences comprises refusal to utilize the procedure; or
a sum of the maximum percentages of the total cost of the procedure which each of the two or more parties are willing to pay is less than 100%.

10. The method of claim 8, wherein:
a “benchmark percentage” equals 100% divided by the number of parties to the dispute;
a “below-benchmark party” is a party willing to pay a maximum percentage of the total cost of adhering to the procedure which is less than the benchmark percentage; and
an “above-benchmark party” is a party willing to pay a maximum percentage of the total cost of adhering to the procedure which is equal to or greater than the benchmark percentage.

11. The method of claim 10, wherein, if the preferences of the two or more parties for the procedure are consistent, and all of the parties are above-benchmark parties, each of the two or more parties pays the benchmark percentage of the total cost of adhering to the procedure.

12. The method of claim 10, wherein, if the preferences of the two or more parties for the procedure are consistent, and one or more of the two or more parties are below-benchmark parties, the party with a lowest maximum willingness to pay, pays the maximum percentage of the total cost of adhering to the procedure which it is willing to pay.

13. A system for interactively establishing a dispute resolution procedure, comprising:
at least one host computer; and
a website coupled to the host computer, the website being accessible to two or more parties, the website comprising an input mechanism adapted to receive input from the two or more parties regarding preferences of the two or more parties for one or more procedures to be followed in arbitrating the dispute;
wherein, via the website, the two or more parties may negotiate and agree upon a set of rules for resolving the dispute.

14. A program stored on a computer-readable medium which, when executed, performs the steps of:
(a) receiving preferences from each of the two or more parties for procedures to be followed in resolving the dispute;
(b) determining whether the preferences of the two or more parties for the procedures are consistent; and
(c) receiving amended responses from the two or more parties if the preferences of the two or more parties are not consistent.

15. The program of claim 14, wherein the program also performs the step of notifying a neutral to resolve the dispute in accordance with the preferences of the two or more parties if the preferences of the two or more parties are consistent.

16. A program stored on a computer-readable medium which, when executed, performs the steps of:
(a) receiving preferences from each of two or more parties to a dispute for procedures to be followed in resolving the dispute; and
(b) determining whether the preferences of the two or more parties for the procedures are consistent.

17. The program of claim 16, wherein the program also performs the steps of:
(c) receiving amended responses from the two or more parties if the preferences of the two or more parties are not consistent; and
(d) notifying a neutral to resolve the dispute in accordance with the preferences of the two or more parties if the preferences are consistent.

18. The method of claim 1, further comprising the step of generating a contractual agreement embodying the preferences of the two or more parties for procedures to be used to resolve the dispute.

19. A method of interactively establishing a dispute resolution procedure, comprising the steps of:
(a) receiving preferences from two or more parties for procedures to be followed in resolving the dispute;
(b) determining whether the preferences of the two or more parties for the procedures are consistent; and
(c) if the preferences of the two or more parties for one of the procedures are not consistent, prompting one or more of the two or more parties for amended preferences.
